(19) United States
(12) Patent Application Publication
(10) Pub. No.: US 2015/0310968 A1
(43) Pub. Date: Oct. 29, 2015

(54) WIRING HARNESS MANUFACTURING METHOD

(71) Applicants: Atsushi Murata, Yokkaichi-shi (JP); Nobuyuki Hirano, Yokkaichi-shi (JP); Osamu Sato, Yokkaichi-shi (JP); Makoto Kamiya, Yokkaichi-shi (JP); Satoshi Tanigawa, Yokkaichi-shi (JP); Shinichi Igarashi, Yokkaichi-shi (JP); Nobumasa Takihara, Yokkaichi-shi (JP); Yukihiro Shirafuji, Yokkaichi-shi (JP); Masamichi Yamagiwa, Yokkaichi-shi (JP); Yutaka Takata, Yokkaichi-shi (JP); Hiroto Ueno, Yokkaichi-shi (JP)

(72) Inventors: Atsushi Murata, Yokkaichi-shi (JP); Nobuyuki Hirano, Yokkaichi-shi (JP); Osamu Sato, Yokkaichi-shi (JP); Makoto Kamiya, Yokkaichi-shi (JP); Satoshi Tanigawa, Yokkaichi-shi (JP); Shinichi Igarashi, Yokkaichi-shi (JP); Nobumasa Takihara, Yokkaichi-shi (JP); Yukihiro Shirafuji, Yokkaichi-shi (JP); Masamichi Yamagiwa, Yokkaichi-shi (JP); Yutaka Takata, Yokkaichi-shi (JP); Hiroto Ueno, Yokkaichi-shi (JP)

(73) Assignees: SUMITOMO WIRING SYSTEMS, LTD., Yokkaichi-shi (JP); AUTONETWORKS TECHNOLOGIES, LTD., Yokkaichi-shi (JP)

(21) Appl. No.: 13/521,510

(22) PCT Filed: Apr. 26, 2011
(86) PCT No.: PCT/JP2011/060121

§ 371 Date: Sep. 11, 2012

(30) Foreign Application Priority Data
Apr. 28, 2010 (JP) 2010-104369
Jul. 12, 2010 (JP) 2010-157677
Jul. 12, 2010 (JP) 2010-157851

(51) Int. Cl. H01B 13/012; H01B 13/06

(52) U.S. Cl. CPC H01B 13/012; H01B 13/06

(57) ABSTRACT

A wire harness manufacturing method includes a first step of covering a periphery of the wire with a molded body (13) having a thermoplastic material, and heating the molded body (13) to a temperature at which plastic deformation by thermo plasticity is possible and pressuring the molded body (13) to have predetermined cross-sectional shape and size. The method also includes a second step of, after the first step, while the molded body (13) has the temperature at which plastic deformation by thermo plasticity is possible, molding the thermoplastic material to have a predetermined axial shape, and cooling the molded body (13) having the predetermined axial shape.

### BACKGROUND OF THE INVENTION

1. Field of the Invention

The present invention relates to a wire harness manufacturing method, and more particularly, to a method of manufacturing a wire harness provided with a shape maintenance member (this shape maintenance member has a function as a protector to guard wires forming the wire harness) to maintain a predetermined part of the wires forming the wire harness.

2. Description of the Related Art

In a vehicle such as an automobile, a wire harness to mutually connect electric devices and electronic devices is arranged. As the wire harness is arranged along a predetermined route inside the vehicle or the like, in some cases, at a wire harness manufacturing stage, the wire harness is formed in a shape appropriate to arrangement. For example, the wire harness (i.e., the wires forming the wire harness) may be formed in a shape corresponding to the shape of the route in which the wire harness is arranged.

Accordingly, a shape maintenance member is attached to a predetermined part (e.g., a branch position of the wires or a position where the wires are folded or bended) of the wires forming the wire harness. Further, in some cases, to protect the wires forming the wire harness, a protector is attached to the predetermined part. Generally, as the shape maintenance member and the protector, a shell-type hollow member (e.g., a cylindrical member in which its axial shape is formed in a predetermined shape) is applied. Further, generally, as the shape maintenance member or the protector, an injection molded product of a resin material which is manufactured by injection molding, is applied.

According to the structure where such shape maintenance member which is an injection molded product is applied, by attaching the shape maintenance member to the predetermined part of the wires forming the wire harness, it is possible to form the attached part into a predetermined shape. Further, according to the structure where the protector which is an injection molded product is applied, the attached part is guarded with the protector. However, the structure where the shape maintenance member which is an injection molded product or the protector is applied has the following problems.

First, to manufacture the shape maintenance member or the protector as above, an injection molding die is required. Generally, an injection molding die is expensive; accordingly, the manufacturing cost and the price of the shape maintenance member or the protector are increased. Further, a work operation to attach the shape maintenance member or protector to the wires forming the wire harness is required, accordingly, the number of process steps is increased, and the manufacturing cost may be increased.

Further, in the structure where the shell-type shape maintenance member or protector is attached to the wires forming the wire harness, in some cases, a gap exists between the wires and the inner peripheral surface of the shape maintenance member or the protector. When vibration or impact is applied to the wire harness, the wires collide with the inner peripheral surface of the shape maintenance member or the protector, and a slapping sound or an impulsive sound occurs. The occurrence of such slapping sound or impulsive sound may degrade the quality of the vehicle or the like to which the wire harness is applied. Further, there is a probability of damage to the wire harness by the collision of the wires with the inner peripheral surface of the shape maintenance member or the protector.

As a structure to prevent the collision of the wires with the inner peripheral surface of the shape maintenance member or the protector, it may be arranged such that a shock-absorbing material (e.g., a sponge-type member) is provided inside the shape maintenance member or the protector. However, in this arrangement, since a work operation to provide the shock-absorbing material inside the shape maintenance member or the protector, the number of steps is increased, and the manufacturing cost may be increased. Further, since the number of parts is increased, the cost of the parts may be increased.

As a structure using a protector which is not an injection molded product, a structure where a protector formed of a thermoplastic material is formed around a flat circuit body is proposed (see Japanese Published Unexamined Patent Application No. 2003-197038). That is, in the structure disclosed in Japanese Published Unexamined Patent Application No. 2003-197038, the flat circuit body is held between two covering members formed of a thermoplastic resin material, and they are subjected to press-molding while they are heated. By this molding, the two covering members are in tight contact with the flat circuit body, and further, the parts of the two covering members in contact are weld-attached. According to this structure, since the two covering members become a protector, a protector which is an injection molded product is unnecessary. Accordingly, the cost of the parts can be reduced.

Generally, the wire harness is arranged along a predetermined route inside the vehicle or the like. Accordingly, it is preferable that the cross-sectional shape and size of the covering member and the axial shape of the covering member are set in correspondence with the shape and size of the route in which the wire harness is arranged. For example, it is preferable that the cross-sectional shape and size of the covering member and the axial shape of the covering member are set approximately the same as the shape and size of the route in which the wire harness is arranged, or set to a shape convenient in the arrangement work operation.

However, it is conceivable that the structure disclosed in Japanese Published Unexamined Patent Application No. 2003-197038 has the following problems. Since the temperature of the covering member immediately after the press molding is high, the covering member is in a plastic-deformable state. Accordingly, when the press-molded wire harness is removed from the molding die and conveyed, it may be distorted due to the self weight of the flat circuit body and/or the covering member. Further, upon removal of the wire harness from the molding die and/or conveyance, when an operator touches the covering member, the touched part and/or its neighbor part may be deformed. In this manner, there is a probability of undesired deformation of the wire harness after the press molding. Accordingly, even when the axial shape of the covering member is formed in correspondence with the shape and size of the route in which the wire harness is arranged, it is difficult to prevent deformation after the molding, and it is difficult to maintain the molded shape.

Further, in the structure disclosed in Japanese Published Unexamined Patent Application No. 2003-197038, the molding die is cooled down and then the wire harness is removed. However, in this arrangement, it is necessary to perform heating and cooling on the molding die by each press molding of the wire harness. Accordingly, time required for manufacturing the wire harness is long.

Further, after the molding or cooling, when the axial shape of the protector or the covering member is to be changed, the protector or the covering member may be damaged. Further, when the protector or the covering member has high rigidity, the axial shape cannot be changed.

Note that as a method of forming the axial shape of the wires into a predetermined shape, a tape may be wrapped around the wires. That is, the plural wires are bound by wrapping the tape around the wires, and the bound wires have a predetermined axial shape. However, in this method, the work operation of tape wrapping requires much labor and time. Further, the appearance of the tape-wrapped structure is bad. Moreover, in the method of manually wrapping the tape, there is a probability of occurrence of variation in quality due to deformation of the shape or the like.

Note that in the structure where an injection molded product is attached to the wires, when a predetermined part of the wire harness has a three-dimensional shape, designing of an injection molding die is difficult, and the equipment cost is increased.

### SUMMARY OF THE INVENTION

In view of the above-described situation, the present invention has an object to provide a method of manufacturing a wire harness having a shape maintenance member to maintain a wire or a bundle of wires in a predetermined shape or a protector to guard the wire or the bundle of wires without using a shape maintenance member or a protector which is an injection molded product, or to provide a wire harness manufacturing method capable of reducing the manufacturing cost of the shape maintenance member or the protector and reducing the number of manufacturing steps, or to provide a wire harness manufacturing method enabling molding of an axial shape of the shape maintenance member or the protector in a predetermined shape. Otherwise, the present invention has an object to provide a wire harness manufacturing method capable of, in manufacture of a wire harness having a shape maintenance member or a protector formed of a thermoplastic material, preventing occurrence of accidental deformation of the thermoplastic material, or to provide a wire harness manufacturing method capable of, in manufacture of a wire harness having a shape maintenance member or a protector formed of a thermoplastic material, enabling molding of an axial shape of the shape maintenance member or the protector in a predetermined shape, or to provide a wire harness manufacturing method capable of, in manufacture of a wire harness having a shape maintenance member or a protector formed of a thermoplastic material, reducing time required for manufacture.

To solve the problems described above, the wire harness manufacturing method for manufacturing a wire harness in which a predetermined part of a wire is covered with a thermoplastic material according to the present invention is summarized as including a first step of covering a periphery of the wire with the thermoplastic material, and heating the thermoplastic material to a temperature at which plastic deformation by thermo plasticity is possible and pressuring the thermoplastic material to mold the thermoplastic material to have predetermined cross-sectional shape and size and a second step of, after the first step, while the thermoplastic material has the temperature at which plastic deformation by thermo plasticity is possible, molding the thermoplastic material to have a predetermined axial shape, and cooling the thermoplastic material having the predetermined axial shape.

The structure can be applied in which, at the second step, by using one molding die with a groove-shaped molding member in which the thermoplastic material having the predetermined axial shape subjected to the first step is fitted and by fitting the thermoplastic material subjected to the first step in the molding member formed in the one molding die, the axial shape of the thermoplastic material is formed to a predetermined shape, and the thermoplastic material is cooled by transmitting heat of the thermoplastic material to the molding die.

The structure can be applied in which, at the first step, the thermoplastic material is molded to have the predetermined cross-sectional shape by heating the thermoplastic material to the temperature at which plastic deformation by thermo plasticity is possible and pressurizing the thermoplastic material, using another molding die.

Further, to solve the problems described above, the wire harness manufacturing method for manufacturing a wire harness in which a predetermined part of a wire is covered with non-woven fabric of a thermoplastic material according to another aspect of the present invention is summarized as including a first step of covering a periphery of the wire with the non-woven fabric of the thermoplastic material, and heating the non-woven fabric of the thermoplastic material to a temperature at which plastic deformation by thermo plasticity is possible and pressurizing the non-woven fabric to mold the non-woven fabric to have predetermined cross-sectional shape and size and a second step of, after the first step, while the non-woven fabric of the thermoplastic material has the temperature at which plastic deformation by thermo plasticity is possible, molding the thermoplastic material to have a predetermined axial shape, and cooling the thermoplastic material having the predetermined axial shape.

In this case, the structure can be applied in which the non-woven fabric has base fiber and binder fiber, wherein the base fiber is formed of a thermoplastic resin material having a predetermined fusing point, wherein the binder fiber has a layer of core fiber and binder material formed on the outer periphery of the core fiber, wherein the core fiber is formed of a thermoplastic resin material having a predetermined fusing point, and wherein the binder material layer is formed of a thermoplastic resin material having a fusing point lower than those of the base fiber and the core fiber.

According to the present invention, a thermoplastic material is heated and pressurized, and a predetermined part of a wire is covered with the thermoplastic material. Then the thermoplastic material molded so as to cover the predetermined part is formed in a predetermined axial shape and is cooled down. With this arrangement, the predetermined part of the wire is covered with the thermoplastic material having a predetermined cross-sectional shape and size and the predetermined axial shape.

Accordingly, it is possible to manufacture a wire harness having a function as a shape maintenance member to maintain a wire or a bundle of wires in a predetermined shape and a function as a protector to guard the wire or the bundle of wires by molding a thermoplastic material to cover a predetermined part of the wire or the bundle of wires without using a shape maintenance member or protector which is an injection molded product. Further, since an injection molding die is not required and an injection molding process is not necessary, in comparison with a structure where the shape maintenance member or the protector which is an injection molded product is applied, it is possible to reduce the manufacturing cost of the wire harness and to reduce the number of manufacturing steps.

Further, in the structure where a shape maintenance member or a protector which is a ready-made product is attached to the predetermined part of the wire, the process of manufacturing the shape maintenance member and the process or attaching the shape maintenance member to the predetermined part of the wire are required. On the other hand, according to the present invention, as the thermoplastic material is directly molded in the predetermined part of the wire (i.e., the molding of the thermoplastic material into a predetermined shape and the attachment to the predetermined part of the wire are performed at the same process), it is possible to reduce the number of process steps in the wire harness manufacturing method. Further, the contents of the work operations are simple in comparison with the structure where the shape maintenance member or a protector which is a ready-made product is attached to the predetermined part of the wire; accordingly, the molding of the axial shape of the thermoplastic material into a predetermined shape is facilitated.

According to the present invention, upon molding of the thermoplastic material into a predetermined axial shape, the thermoplastic material is in a state where plastic deformation by thermo plasticity does not occur. Accordingly, it is possible to prevent accidental deformation of the thermoplastic material molded to cover the predetermined part of the wire.

Further, it is possible to cool down the thermoplastic material molded by heating and pressurization while molding it in a predetermined axial shape using a molding die different from a molding die used in the heating and press molding. Accordingly, it is possible to maintain the molding die used upon heating and pressurization of the thermoplastic material at a temperature to heat the thermoplastic material. It is not necessary to heat and cool the molding die, used in heating and pressurization of the thermoplastic material, upon each molding of the thermoplastic material. Accordingly, time for cooling the molding die used upon heating and pressurization of the thermoplastic material is not required. Thus it is possible to reduce the time for manufacture of the wire harness. Especially, it is possible to continuously perform heating and pressurization on plural thermoplastic materials. Accordingly, upon mass production of the wire harness, it is possible to improve the productive efficiency.

According to the present invention, the thermoplastic material is molded to have a predetermined axial shape and cooled down to a temperature at which plastic deformation by thermo plasticity does not occur, by using the above-described one predetermined molding die. Accordingly, the molded thermoplastic material, when removed from the above-described predetermined molding die, has a fixed shape, and plastic deformation by thermo plasticity does not occur. Accordingly, it is possible to improve the dimensional precision of the thermoplastic material without causing accidental and/or undesired deformation in the molded thermoplastic material. Further, it is possible to facilitate handling of the molded thermoplastic material.

That is, in the structure where the thermoplastic material is molded to have predetermined cross-sectional shape and size and at the same time to have a predetermined axial shape, using a single molding die, the thermoplastic material immediately after the molding has a temperature at which plastic deformation by thermo plasticity is possible. Accordingly, accidental and/or undesired deformation may occur after the molding. On the other hand, in the wire harness manufacturing method according to the embodiments of the present invention, the thermoplastic material, when removed from the above-described single molding die, already has a temperature at which thermoplastic deformation by thermo plasticity does not occur. Accordingly, accidental and/or undesired deformation does not occur even when an operator touches the molded thermoplastic material.

Note that in the structure where the thermoplastic material is molded using a single molding die, it may be arranged such that he thermoplastic material is molded then the molding die is cooled down and the thermoplastic material is removed from the die. However, in this arrangement, since it takes time for cooling the molding die, the time for molding the thermoplastic material is prolonged, and the productive efficiency is lowered. Further, since the thermoplastic material is continuously heated with the molding die before the molding die is cooled down, it is difficult to control the property of the thermoplastic material. Further, there is a probability of thermal transmission to the wire covered with the thermoplastic material to damage the wire. Further, since it is necessary to heat and cool the molding die upon each molding of the thermoplastic material, the time required for molding of the thermoplastic material is prolonged.

On the other hand, in the structure using another molding die for heating the thermoplastic material to a temperature at which plastic deformation by thermo plasticity is possible and pressurizing the thermoplastic material, it is not necessary to cool down the other single molding die and it is possible to maintain a predetermined temperature. Accordingly, it is possible to improve the operating efficiency of the other molding die. Further, in comparison with the structure where the molding die is cooled down, since the time required for cooling the thermoplastic material can be shorter than the time required for cooling the molding die (i.e., the thermal storage amount in the molded thermoplastic material is smaller than the thermal storage amount in the molding die), the time required for molding the thermoplastic material (especially cooling) can be shortened.

Further, as long as the unit to heat the thermoplastic material is provided only in the one molding die, it not necessary to provide the unit in the other molding die. Further, as long as the above-described one molding die has a structure to mold the thermoplastic material to have a predetermined axial shape, it is not necessary to use a specialized molding die. A real member in which the predetermined part of the wire harness is arranged is applicable. Accordingly, it is possible to reduce the manufacturing cost of the above-described one molding die, and it is possible to reduce the equipment cost used in the wire harness manufacturing method according to the embodiments of the present invention, or prevent an increase of the equipment cost.

Further, according to another aspect of the present invention, the member covering the predetermined part of the wire is formed with non-woven fabric of a thermoplastic material. Accordingly, the member covering the predetermined part of the wire is a layer including plenty of air. In the layer including plenty of air, as the heat insulating property can be improved with the air, the layer is not easily cooled. According to the other aspect of the present invention, (in comparison with a case where the member covering the predetermined part of the wire is a bulk,) the member covering the predetermined part of the wire is not easily cooled after the heating and pressurization of the thermoplastic material (non-woven fabric) covering the predetermined part of the wire and before the molding of the material to have a predetermined axial shape. This facilitates the work operation to form the thermoplastic material (non-woven fabric) covering the predetermined part of the wire to have the predetermined axial shape.

### BRIEF DESCRIPTION OF THE DRAWINGS

FIG. 1 is an external perspective diagram showing a predetermined part (in which a shape maintenance member molded into a predetermined shape is provided) of a wire harness manufactured using a wire harness manufacturing method according to an embodiment of the present invention.

FIG. 2 is an external perspective diagram schematically showing structures of principal elements of a lower die holding tool and a lower die of a first molding die.

FIG. 3 is an external perspective diagram schematically showing structures of principal elements of an upper die of the first molding die.

FIGS. 4A to 4D are perspective and cross-sectional diagrams schematically showing a predetermined process, included in a first step, of wrapping wires with a molded body.

FIG. 5 is a cross-sectional diagram schematically showing a predetermined process, included in the first step, of accommodating the wires and the molded body in the lower die holding tool.

FIG. 6 is a cross-sectional diagram schematically showing a predetermined process, included in the first step, of engaging the lower die holding tool with an engagement member of a lower die of the first molding die.

FIG. 7 is a cross-sectional diagram schematically showing a predetermined process, included in the first step, of heat and press molding of the molded body with the upper die and the lower die of the first molding die.

FIG. 8 is a cross-sectional diagram schematically showing a predetermined process, included in the first step, of removing the wires and the shape maintenance member molded to have a predetermined cross-sectional shape, from the upper die and the lower die of the first molding die.

FIG. 9 is an external perspective diagram showing the predetermined part of the wire harness subjected to the first step.

FIG. 10 is an exploded perspective diagram schematically showing a structure of a second molding die.

FIG. 11 is a photograph showing a cross-section of the shape maintenance member molded using a molded body formed with non-woven fabric of a thermoplastic material.

### DETAILED DESCRIPTION OF THE PREFERRED EMBODIMENTS

Hereinbelow, preferred embodiments of the present invention will now be described in detail in accordance with the accompanying drawings.

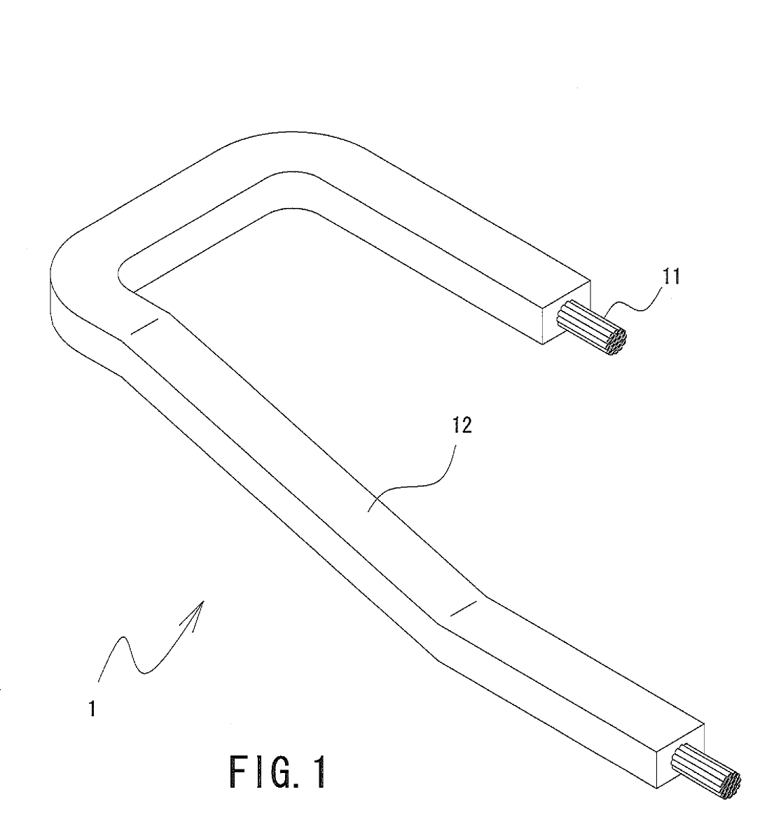

FIG. 1 is an external perspective diagram showing a predetermined part (in which a shape maintenance member 12 molded into a predetermined shape is provided) of a wire harness 1 manufactured using a wire harness manufacturing method according to an embodiment of the present invention. Note that for the sake of convenience of explanation, the wire harness 1 manufactured using the wire harness manufacturing method according to the embodiment of the present invention may be referred to as a “present wire harness 1”.

The present wire harness 1 as a whole has a predetermined number of wires 11 of a predetermined type, and the wires 11 are bundled in a predetermined form (or bound). The bundled (or bound) wires 11 form a trunk line or a branch line of the present wire harness 1. Predetermined types of connectors and the like are attached to ends of the respective wires 11 included in the present wire harness 1. Note that the type and the number of the wires 11 included in the present wire harness 1, the entire shape of the present wire harness 1 (e.g., the shape of the trunk line or branch line, the number of branch lines, the branch form and the like), the structures of the connectors and the like attached to the respective wires 11, and the like, are appropriately set as needed and not limited. Note that in the present invention, “wire” has a meaning of a single wire, and further, also includes a meaning of plural wires (i.e., the trunk line or branch line of the present wire harness).

As shown in FIG. 1, the shape maintenance member 12 is provided in a predetermined part of the present wire harness 1. That is, the predetermined part of the present wire harness 1 has the wires 11 and the shape maintenance member 12, and the wires 11 are covered with the shape maintenance member 12. The shape maintenance member 12 has a function of maintaining the wires 11 in a predetermined shape (especially a function of maintaining an axial shape of the wires 11 in a predetermined shape), and has a function of protecting the wires 11 (a function as a so-called “protector”). In the present wire harness 1, the position and range of the part in which the shape maintenance member 12 is provided (the predetermined part of the present wire harness 1 in the present invention) are not particularly limited, but appropriately provided in a part to maintain the axial line of the wires 11 in a predetermined shape, a part to protect the wires 11, or the like.

The shape and size of the cross section and the axial shape of the shape maintenance member 12 are appropriately set in correspondence with the shape or the like of space of a region where the present wire harness 1 is arranged. For example, the predetermined part of the present wire harness 1 may be formed in approximately the same shape and size of the space of a region where the predetermined part is arranged, or may be formed in a shape convenient for arrangement of the present wire harness. In this manner, the shape and size of the cross section and the axial shape of the shape maintenance member 12 are not particularly limited.

The shape maintenance member 12, having thermo plasticity, is formed of an elastic-deformable material (especially a material capable of compression deformation to reduce its apparent volume). For example, it is formed of non-woven fabric of a thermoplastic resin material or the like, foam or the like. Note that for the sake of convenience of explanation, the member as a material of the shape maintenance member 12 will be referred to as a “molded body” 13.

As the non-woven fabric used as the molded body 13, fabric having an intertwined structure of base fiber and binder fiber is applicable. The base fiber is formed of a thermoplastic resin material having a predetermined fusing point. The binder fiber has a structure where a binder material layer is formed on the outer periphery of core fiber. The core fiber is formed of the same thermoplastic resin material as the base fiber. The binder material layer is formed of a thermoplastic resin material having a fusing point lower than that of the base fiber and the core fiber. Note that for the sake of convenience of explanation, the non-woven fabric having this structure will be referred to as “first non-woven fabric”.

When the first non-woven fabric is heated to a temperature equal to or higher than a predetermined temperature, it is in a plastic-deformable state by thermo plasticity of the base fiber and the binder fiber. Especially, when the first non-woven fabric is heated to a temperature band higher than the fusing point of the binder material of the binder fiber and lower than the fusing point of the base fiber and the core fiber of the binder fiber, the base fiber and the core fiber of the binder fiber are plastic-deformable by thermo plasticity while their solid state (fiber state) is maintained. On the other hand, when the first non-woven fabric is heated to this temperature band, the binder material of the binder fiber is melted, and flows between a gap between the base fiber and the core fiber of the binder fiber. Accordingly, thereafter, when the first non-woven fabric is cooled to the temperature lower than the fusing point of the binder material, the binder material returns to the solid state, and having an adhesive-like (or hot-melt resin-like) aspect, connects the base fiber and the core fiber of the binder fiber.

Accordingly, in a case where the first non-woven fabric is heated to a temperature band higher than the fusing point of the binder material of the binder fiber and lower than the fusing point of the base fiber and the core fiber of the binder fiber, formed into a predetermined shape in this temperature band, then cooled to a temperature at which the base fiber and the binder fiber are not plastic-deformable by thermo plasticity, the shape formed in the above-described temperature band is maintained. Further, as the melted binder material is solidified to connect the base fiber and the core fiber of the binder fiber, the non-woven fabric is hardened in comparison with a state before heating.

Note that for the sake of convenience of explanation, the temperature band in which the base fiber and the binder fiber are plastic-deformable by thermo plasticity will be referred to as a “first plasticization temperature band” of the first non-woven fabric. Further, in the “first plasticization temperature band” of the first non-woven fabric, a temperature band equal to or higher than the fusing point of the binder material of the binder fiber and lower than the fusing point of the base fiber and the core fiber of the binder fiber will be referred to as a “second plasticization temperature band” of the first non-woven fabric.

As the base fiber of the first non-woven fabric, PET (polyethylene terephthalate) fiber is applicable. As the binder fiber of the first non-woven fabric, fiber having PET core fiber and binder material layer formed of PET and PEI (polyethylene isophthalate) copolymer resin, obtained by forming the binder material layer on the periphery of the core fiber, is applicable. The fusing points of the base fiber and the core fiber (PET) of the above-structured non-woven fabric are about 250° C. The fusing point of the binder material is 110 to 150° C. Accordingly, the second plasticization temperature band of the first non-woven fabric is 110 to 250 ° C.

In addition, as the molded body 13, non-woven fabric of a thermoplastic resin material without binder fiber is applicable. For the sake of convenience of explanation, this non-woven fabric will be referred to as a “second non-woven fabric”. For example, PET non-woven fabric is applicable. Further, as the molded body 13, foam of a thermoplastic material is applicable. For example, PET foam is applicable. When the second non-woven fabric and the foam applied to the molded body 13 are heated to a temperature lower than the fusing point of the thermoplastic resin material as their material and around the fusing point, they are plastic-deformable by thermo plasticity.

The surface part (outer surface and its neighbor part) of the shape maintenance member 12 is hard in comparison with the central part (a part in contact with the predetermined part of the wires 11 and its neighbor part). More particularly, the surface part of the shape maintenance member 12 is harder than the molded body 13 before molding to the shape maintenance member 12 by the wire harness manufacturing method according to the embodiment of the present invention. The hard surface part has a function of maintaining the axial shape of the predetermined part of the wires in a predetermined shape and a function of protecting the predetermined part of the wires 11.

On the other hand, the central part of the shape maintenance member 12 is soft in comparison with the surface part. More particularly, the central part of the shape maintenance member 12 has the property of the molded body 13 before molding into the shape maintenance member 12 more than the surface part. The central part of the shape maintenance member 12, elastically in contact with the predetermined part of the wires 11 and wrapping the predetermined part of the wires 11, has a function of protecting the predetermined part of the wires 11 from impact and/or vibration. Further, the central part of the shape maintenance member 12 has a function as a soundproof material. That is, since the shape maintenance member 12, having elasticity, is in contact with and wraps the predetermined part of the wires 11, even upon application of vibration or external force to the present wire harness 1, transmission of the vibration or external force to the wires 11 is prevented or suppressed. Further, as the wires 11 and the shape maintenance member 12 are in elastic contact with each other, occurrence of impulsive sound or the like is prevented.

Next, the wire harness manufacturing method according to the embodiment of the present invention will be described. The wire harness manufacturing method according to the embodiment of the present invention includes a step of covering the predetermined part of the wires 11 forming the present wire harness 1 with the shape maintenance member 12 (step of forming the shape maintenance member 12 around the wires 11), and a step of molding the shape maintenance member 12 to have a predetermined axial shape. For the sake of convenience of explanation, the step of covering the predetermined part of the wires 11 with the shape maintenance member 12 will be referred to as a “first step”, and the step of molding the shape maintenance member 12 into a predetermined shaped axial line will be referred to as a “second step”.

The content of the first step is as follows.

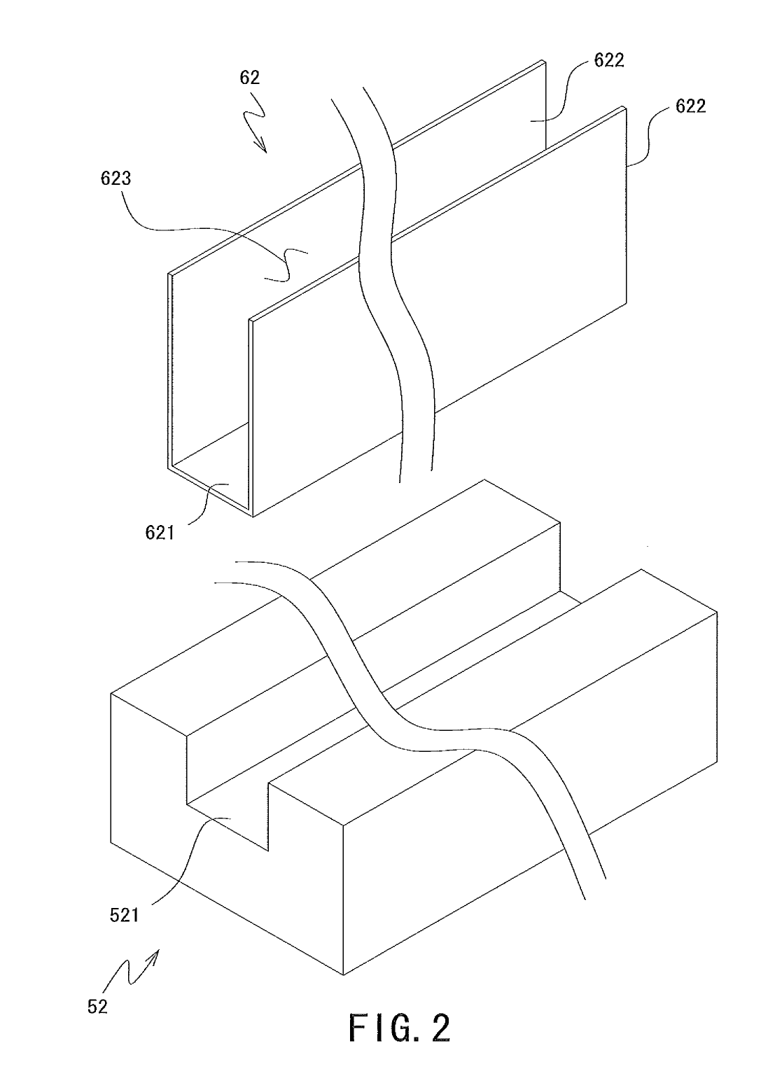

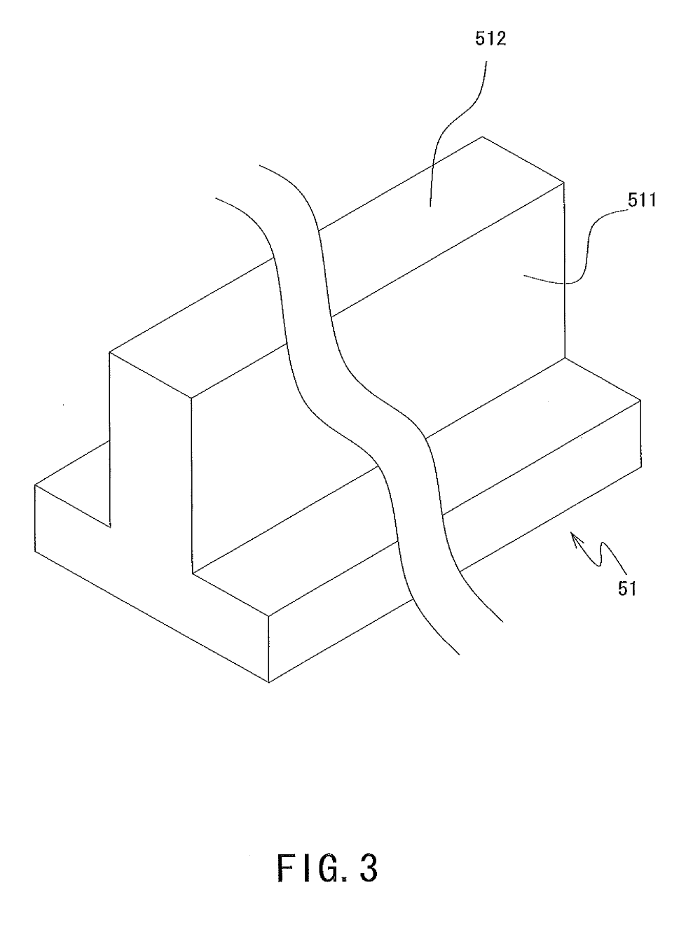

At the first step, a first molding die 5 and a lower die holding tool 62 are used. The first molding die 5 has a pair of upper die 51 and lower die 52 (for example, metal molding die is applicable as any of the dies). FIG. 2 is an external perspective diagram schematically showing structures of principal elements of the lower die holding tool 62 and the lower die 52 of the first molding die 5. FIG. 3 is an external perspective diagram schematically showing structures of principal elements of the upper die 51 of the first molding die 5. Regarding the lower die holding tool 62 and the lower die 52 of the first molding die 5, the upper side in FIG. 2 is the side opposite to the upper die 51 of the first molding die 5. Regarding the upper die 51 of the first molding die 5, the upper side in FIG. 3 is the side opposite to the lower die holding tool 62 and the lower die 52 of the first molding die 5. For the sake of convenience of explanation, regarding the lower die holding tool 62 and the lower die 52 of the first molding die 5, the side of the first molding die 5 opposite to the upper die 51 will be referred to as an “upper side”, and regarding the upper die 51 of the first molding die 5, the side of the lower die holding tool 62 and the first molding die 5 opposite to the lower die 52 will be referred to as a “lower side”. In FIG. 2, the upper side is the upper side, and in FIG. 3, the upper side is the lower side.

The lower die holding tool 62 is a machine tool (or jig) having a function of pressurizing the molded body 13 to mold it into the shape maintenance member 12 having predetermined shape and size and a function of maintaining the shape maintenance member 12 molded in the predetermined shape and size (molded body after the molding), in the predetermined shape and size (in other words, preventing accidental or undesired deformation of the shape maintenance member 12), at the first step.

The lower die holding tool 62 has a groove-shaped concave member 623 which is opened upward. More particularly, the lower die holding tool 62 has a bottom member 621 which has a predetermined width and which extends in a predetermined axial direction and a wall member 622 which extends upward from both sides of the bottom member 621 in the axial direction. A region surrounded by an upper surface of the bottom member 621 and an inner surface of the wall member 622 on the both sides of the bottom member 621 forms the groove-shaped concave member 623 which is opened upward. Accordingly, the lower die holding tool 62 as a whole has a structure with an approximately U-shaped cross section.

The cross-sectional shape of a part around the bottom member of the groove-shaped concave member 623 (this is the upper surface of the bottom member 621 the upper surface of the bottom member 621 and a part of the inner surface of the wall member 622 in the vicinity of the bottom, in contact with the molded body 13 when the molded body 13 is pressurized) (here, the cross sectional shape is obtained by cutting the lower die holding tool 62 in a direction orthogonal to the axial direction) is set to shape and size in correspondence with shape and size of the cross section of the molded shape maintenance member 12. For example, when the shape maintenance member 12 is formed to have an approximately circular cross-sectional shape, the upper surface of the bottom member 621 is formed to an approximate semi-circular shape. Further, when the shape maintenance member 12 is formed to have an approximately rectangular cross-sectional shape, the upper surface of the bottom member 621 and the inner surface of the wall member 622 on the both sides are formed so as to shape the cross-section of a region surrounded by these surfaces into an approximately rectangular shape. That is, the upper surface of the bottom member 621 is approximately flat, at least part of the wall member 622 on both sides in the vicinity of the bottom member 621 is approximately flat, and at least the part of the wall member 622 on both sides in the vicinity of the bottom member 621 is approximately upright at right angle to the upper surface of the bottom member 621.

The lower die holding tool 62 is formed of a material with high thermal conductivity, and has a structure with a small thermal storage amount (i.e., it easily follows an ambient temperature change). Especially, in the structure, heat is easily transmitted between the inside and the outside of the groove-shaped concave member 623. More particularly, it is formed of a thin metal plate by sheet metal working or the like. When the lower die holding tool is formed of a thin metal plate or the like, heat is easily transmitted in a thickness direction of the metal plate, and the mass of the lower die holding tool 62 can be reduced. It is possible to reduce the thermal storage amount. Further, the bottom member 621 and the wall member 622 are integrally formed by sheet metal working or the like using a single metal plate. When the bottom member 621 and the wall member 622 are integrally formed from a single metal plate or the like, it is not necessary to assemble separate parts. Accordingly, in comparison with a structure where separate parts are assembled, it is possible to prevent increment in the cost of the parts and the manufacturing cost of the lower die holding tool 62. Further, it is possible to reduce the labor of manufacture of the lower die holding tool 62.

The shape of an outer surface of the groove-shaped concave member 623 of the lower die holding tool 62 (the shape of a lower surface of the bottom member 621 and the shape of an outer surface of the wall member 622) is not particularly limited. When the lower die holding tool 62 is formed of a thin metal plate and is formed by sheet metal working or the like, the shape of the lower surface of the bottom member 621 of the lower die holding tool 62 of the bottom member 621 and the shape of the outer surface of the wall member 622 are approximately analogous to that of the upper surface of the bottom member 621 and that of the inner surface of the wall member 622.

The lower die 52 of the first molding die 5 is a machine tool to heat and pressurize the molded body 13 via the lower die holding tool 62, together with the upper die 51 of the first molding die 5, to mold the the shape maintenance member 12. That is, the molded body 13 is thermoplastic-deformed by utilizing thermo plasticity and formed into the shape maintenance member 12 having predetermined cross-sectional shape and size.

An engagement member 521 is formed on the upper side of the lower die 52 of the first molding die 5. The engagement member 521 is a groove-shaped concave member which is opened upward, and has a structure to accommodate the entire or a part of the lower side of the lower die holding tool 62 (the bottom member 621 and a part of the wall member 622 in the vicinity of the bottom member 621). In FIG. 2, the structure can accommodate a part in the lower side of the lower die holding tool 62. By engagement of the lower die holding tool 62 with the engagement member 521, it is possible to place the groove-shaped concave member 623 of the lower die holding tool 62, with its open side upward (toward the upper die 51 of the first molding die 5), on the upper side of the lower die 52 of the first molding die 5.

The shape and size of the engagement member 521 of the lower die 52 of the first molding die 5 are set such that, when the lower die holding tool 62 is engaged with the engagement member 521, the surface of the engagement member 521 is in contact with approximately the entire part of the outer surface of the lower die holding tool 62 engaged with the engagement member 521 (approximately the entire outer surface of the lower die holding tool 62 or the lower surface of the bottom member 621 of the lower die holding tool 62 and a part of the outer surface of the wall member 622 in the vicinity of the bottom member 621).

For example, the shape and size of the engagement member 521 of the lower die 52 of the first molding die 5 are set to be approximately the same as those of the outer surface of the lower die holding tool 62 (the outer surface of the bottom member 621 and the outer surface of the wall member 622) or slightly greater shape and size. Accordingly, as shown in FIG. 2, when the cross-sectional shape of the bottom member 621 of the lower die holding tool 62 and a part of the wall 622 in the vicinity of the bottom member 621 is an approximately rectangular shape, the cross-sectional shape of the engagement member 521 is set to be an approximately rectangular shape. Further, when the cross-sectional shape of the bottom member 621 of the lower die holding tool 62 is an approximately semi-circular shape, the cross-sectional shape of the engagement member 521 is set to be an approximately semi-circular shape or the bottom of the engagement member 521 is set to be an approximately semi-circular shape.

The lower die 52 of the first molding die 5 has a heating unit (not shown). With this heating unit, the surface of the engagement member 521 can be maintained at a predetermined temperature. Note that the “predetermined temperature” will be described later. As the heating unit, various known heating units are applicable. For example, a structure using a heating wire as the heating unit, where the heating wire is embedded in the lower die 52 of the first molding die 5, or a structure where the heating wire is attached to the outer periphery of the lower die 52 of the first molding die 5 is applicable. Further, a structure where a channel for passing fluid (e.g., a hole) is formed inside the lower die 52 of the first molding die 5, and the fluid at controlled temperature (temperature-controlled air, liquid (oil or the like), vapor (superheated steam or the like)) is passed through the channel is applicable. In this manner, as long as the heating unit has a structure to maintain the lower die 52 (especially the surface of the engagement member 521) of the first molding die 5 at a predetermined temperature, the type and structure of the heating unit are not limited.

In this manner, it is possible to heat the lower die holding tool 62 engaged with the engagement member 521 to a predetermined temperature with the lower die 52 of the first molding die 5. As the shape and size of the engagement member 521 are as described above, it is possible to approximately uniformly heat the part of the lower die holding tool 62 engaged with the engagement member 521.

The upper die 51 of the first molding die 5 is a machine tool to heat and pressurize the molded body 13 together with the lower die 52 of the first molding die 5 and the lower die holding tool 62.

A part of the lower side of the upper die 51 of the first molding die 5 is fit-inserted between side parts of the wall member 622 of the lower die holding tool 62. More particularly, as shown in FIG. 3, a convex-shaped structure 511 projected downward is formed in the upper die 51 of the first molding die 5. The entire or a part of the lower side of the convex-shaped structure ember 511 is fit-inserted between the side parts of the wall member 622 of the lower die holding tool 62. Accordingly, the width of the convex-shaped structure 511 (the size in a direction orthogonal to the axial direction) is approximately the same as or slightly smaller than the interval between the side parts of the wall member 622 of the lower die holding tool 62.

Note that in addition to the structure as shown in FIG. 3, a structure where the entire upper die 51 of the first molding die 5 lower die holding tool 62 is formed to have size and shape so as to be fit-inserted between the side parts of the wall member 622 of the lower die holding tool 62 may be used.

A pressure surface 512 is formed on the lower side of the upper die 51 of the first molding die 5. The pressure surface 512 is a part to pressurize and heat the molded body 13 to mold the shape maintenance member 12 having a predetermined cross-sectional shape. When the lower die holding tool 62 is engaged with the engagement member 521 of the lower die 52 of the first molding die 5, the pressure surface 512 is opposite to the upper surface of the bottom member 621 of the lower die holding tool 62. As shown in FIG. 3, in a structure where the downward convex-shaped structure 511 is formed in the upper die 51 of the first molding die 5, the lower surface of the convex-shaped structure 511 is the pressure surface 512. On the other hand, when the entire upper die 51 of the first molding die 5 is fit-inserted between the side parts of the lower die holding tool 62, approximately the entire surface of the the lower side of the upper die 51 of the first molding die 5 is the pressure surface 512.

The cross-sectional shape and size of the pressure surface 512, when cut along a plane orthogonal to the axial direction of the convex-shaped structure 511 (or the entire upper die 51 of the first molding die 5), are set in correspondence with the cross-sectional shape and size of the shape maintenance member 12 to be molded. That is, the pressure surface 512 is formed to have approximately the same shape as that of a part of the outer peripheral surface of the molded shape maintenance member 12. For example, when the cross-sectional shape of the shape maintenance member 12 is an approximate rectangular shape, the pressure surface 512 of the upper die 51 of the first molding die 5 is formed to an approximate flat surface. Further, when the cross-sectional shape of the shape maintenance member 12 is an approximate circular shape, the pressure surface 512 has an upwardly-fallen approximate semi-circular cross-sectional shape.

The upper die 51 of the first molding die 5 has a heating unit (not shown). With this heating unit, it is possible to maintain, especially the pressure surface 512, at a predetermined temperature. The “predetermined temperature” is the same as that of the lower die 52 of the first molding die 5. Further, the same heating unit as that of the lower die 52 of the first molding die 5 is applicable. Accordingly, the explanations of the temperature and the heating unit will be omitted.

When the lower die holding tool 62 is engaged with the engagement member 521 of the lower die 52 of the first molding die 5, and the upper die 51 and the lower die 52 of the first molding die 5 are brought closer to each other in that state, the entire or a part of the lower side of the upper die 51 of the first molding die 5 is removably fit-inserted between the side parts of the wall member 622 of the lower die holding tool 62 engaged with the engagement member 521 of the lower die 52 of the first molding die 5. The upper surface of the bottom member 621 of the lower die holding tool 62 and the pressure surface 512 of the upper die 51 of the first molding die 5 are opposite to each other with a predetermined interval therebetween.

When the upper die 51 and the lower die 52 of the first molding die 5 are close to each other within a predetermined distance, the shape and size of the space surrounded by the inner surface of the groove-shaped concave member 623 of the lower die holding tool 62 (the upper surface of the bottom member 621 or the upper surface of the bottom member 621 and a part of the mutually opposed surfaces of the wall member 622 in the vicinity of the bottom member 621) and the pressure surface 512 of the upper die 51 of the first molding die 5 are the shape and size of the shape maintenance member 12 formed in the predetermined part of the present wire harness 1. Accordingly, the size and shape of the inner surface of the concave member 623 of the lower die holding tool 62 in the vicinity of the bottom member 621 and the size and shape of the pressure surface 512 of the upper die 51 of the first molding die 5 are set based on the size and shape of the shape maintenance member 12.

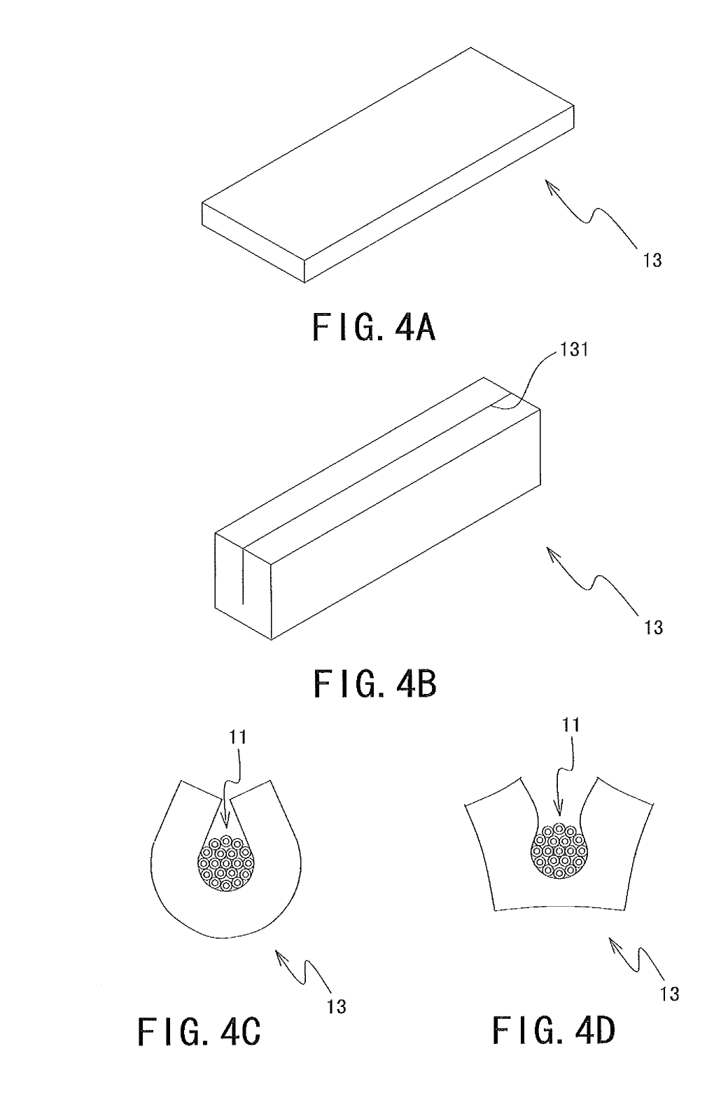

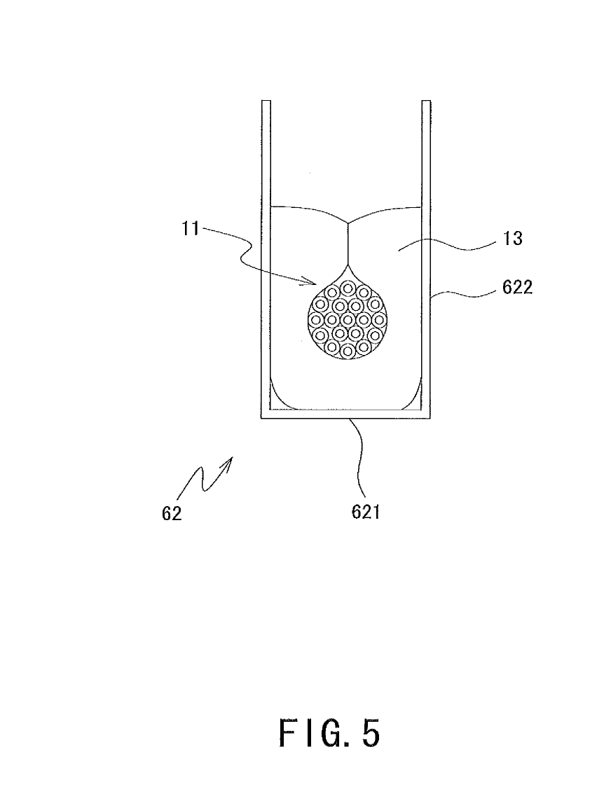

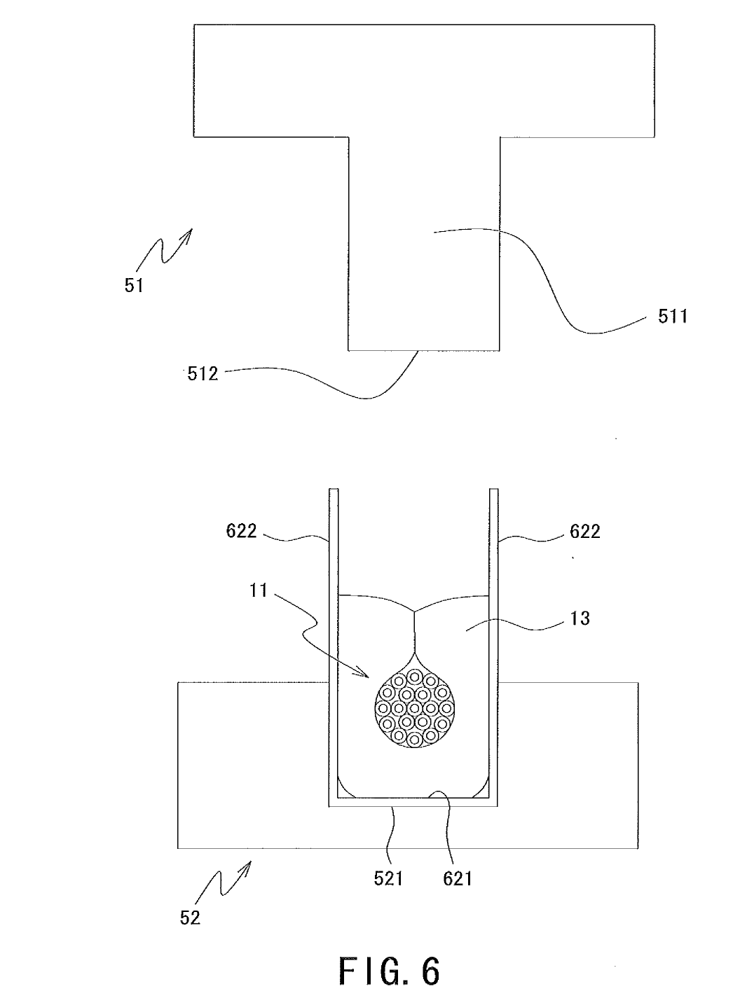

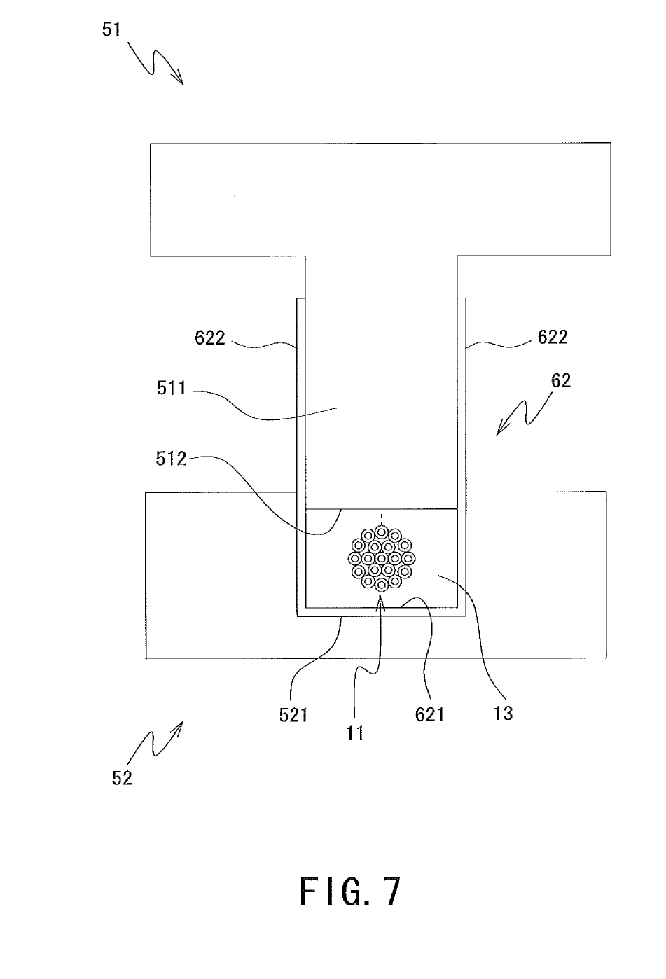

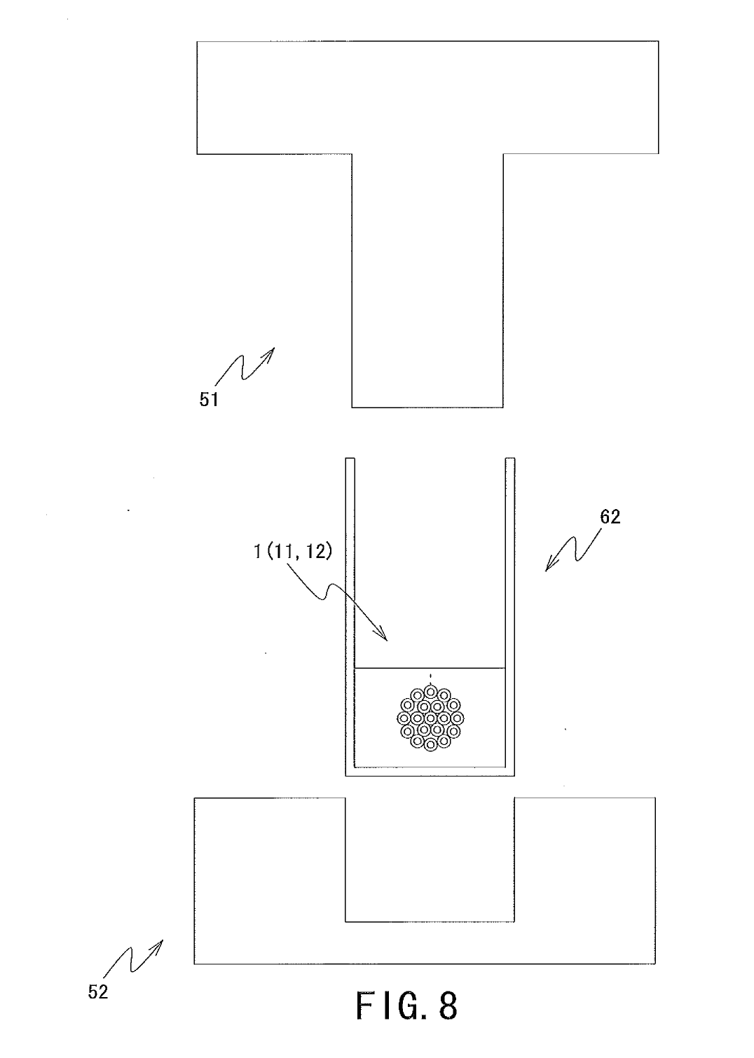

FIGS. 4A to 4D and FIGS. 5 to 8 are cross-sectional diagrams respectively schematically showing a predetermined process included in the first step. More particularly, FIGS. 4A to 4D show a process of wrapping the wires 11 with the molded body 13. FIG. 5 shows a process of accommodating the wires 11 and the molded body 13 in the lower die holding tool 62. FIG. 6 shows a process of engaging the lower die holding tool 62 with the engagement member 521 of the lower die 52 of the first molding die 5. FIG. 7 shows a process of heat-and-press molding of the molded body 13 with the upper die 51 and the lower die 52 of the first molding die 5. FIG. 8 shows a process of removal of the wires 11 and the shape maintenance member 12 molded to have a predetermined cross-sectional shape from the upper die 51 and the lower die 52 of the first molding die 5.

As shown in FIGS. 4A to 4D, the predetermined part of the wires 11 is wrapped with the molded body 13. The molded body 13 has an approximately flat-shaped structure as shown in FIG. 4A, or has a bar-shaped structure having a slit 131 (notch or groove from the outer peripheral surface toward the inside) along an axial direction as shown in FIG. 4B. When the approximately flat-shaped molded body 13 is applied, the molded body 13 is bended into an approximate “U” shape, to hold and wrap the predetermined part of the wires 11, as shown in FIG. 4C. On the other hand, when the bar-shaped molded body 13 is applied, the predetermined part of the wires 11 is inserted into the slit 131 formed in the molded body 13 such that the predetermined part of the wires 11 is wrapped with the molded body 13.

The shape and size of the cross-section of the molded body 13 are not particularly limited as long as the cross-sectional area of the molded body 13 wrapping the predetermined part of the wires 11 (the cross-sectional area including the predetermined part of the wires 11) is greater than the cross-sectional area of the molded shape maintenance member 12 (the cross-sectional area including the predetermined part of the wires 11). In other words, the shape and size of the cross-section of the molded body 13 are not particularly limited as long as the contour of the cross section of the molded shape maintenance member 12 (contour of the cross section including the predetermined part of the wires 11) is included inside the contour of the cross section of the molded body 13 including the predetermined part of the wires 11. The other properties of the molded body 13 are not particularly limited.

Next, as shown in FIG. 5, the molded body 13 wrapping the predetermined part of the wires 11 is accommodated in the groove-shaped concave member 623 of the lower die holding tool 62. The molded body 13 accommodated in the groove-shaped concave member 623 of the lower die holding tool 62, held between the both side parts of the wall member 622, is maintained in the state where it wraps the predetermined part of the wires 11.

Next, as shown in FIG. 6, the lower die holding tool 62 accommodating the molded body 13 wrapping the predetermined part of the wires 11 is engaged with the engagement member 521 of the lower die of the first molding die 5. That is, the lower die holding tool 62 is placed on the upper side of the lower die 52 of the first molding die 5.

The pressure surface 512 of the upper die 51 of the first molding die 5 and the engagement member 521 of the lower die of the first molding die 5 are maintained at a predetermined temperature with the heating unit. When the first non-woven fabric is applied to the molded body 13, a temperature in the second plasticization temperature band of the first non-woven fabric is applied as the “predetermined temperature”. When the second non-woven fabric or foam is applied as the molded body 13, a temperature equal to or higher than the fusing point of the material of the second non-woven fabric or the material of the foam and around the fusing point is applied.

Next, as shown in FIG. 7, the upper die 51 and the lower die 52 of the first molding die 5 are brought closer to each other. Then, the size and shape of the space surrounded by the pressure surface 512 of the upper die 51 of the first molding die and the upper surface of the bottom of the lower die holding tool 62 and the inner surface of the side parts of the lower die holding tool 62 (or space surrounded by the pressure surface 512 of the upper die 51 of the first molding die 5 and the upper surface of the lower die holding tool 62) are the shape and size of the molded shape maintenance member 12. In this arrangement, the molded body 13 is compression-deformed and heated with the upper die 51 of the first molding die 5 and the lower die 52 of the first molding die 5 via the lower die holding tool 62. Then, this state is maintained (i.e., the heating and pressurization are continuously performed on the molded body 13) for a predetermined period.

The “predetermined time” is as follows.

When the first non-woven fabric is applied to the molded body 13, in the molded body 13, the temperature of a part in contact with the inner surface of the groove-shaped concave member 623 of the lower die holding tool 62 and the pressure surface 512 of the upper die 51 of the first molding die 5 and its neighbor part (in other words, a part as the surface part of the shape maintenance member 12) is raised to the second plasticization temperature band within the predetermined time. However, the temperature of a part in contact with the wires 11 and its neighbor part (in other words, a part as the central part of the shape maintenance member 12) is not raised to the second plasticization temperature band within the predetermined time. Especially when the wires 11 respectively have a structure where a core wire is covered with a covering member, time not to damage the covering member by heat (in other words, time not to melt or degenerate the covering members of the wires 11 by heat) is applied. Note that there is no problem when the temperature of the part in contact with the wires 11 and its neighbor part is within or without the first plasticization temperature band.

When the second non-woven fabric or foam is applied to the molded body 13, in the molded body 13, the temperature of a part in contact with the inner surface of the groove-shaped concave member 623 of the lower die holding tool 62 and the pressure surface 512 of the upper die 51 of the first molding die 5 and its neighbor part becomes equal to or higher than the fusing point of the second non-woven fabric or the foam within the predetermined period. However, the temperature of a part in contact with the wires 11 and its neighbor part does not become the temperature equal to the fusing point within the predetermined period. Especially when the wires 11 respectively have a structure where a core wire is covered with a covering member, time not to damage the covering member by heat is applied.

When the molded body 13 is heated at the “predetermined temperature” and pressurized for the “predetermined time”, the shape maintenance member 12 is formed by the following process.

When the first non-woven fabric is applied to the molded body 13, in the molded body 13, a part, having a temperature raised to the first plasticization temperature band is plastic-deformed by thermo plasticity. While the first non-woven fabric is heated and pressurized, the surface part of the molded body 13 (the part in contact with the inner surface of the lower die holding tool 62 and its neighbor part and the part in contact with the pressure surface 512 of the upper die 51 of the first molding die 5 and its neighbor part) is higher in comparison with the central part (the part in contact with the predetermined part of the wires 11 and its neighbor part). Accordingly, the degree of plastic deformation of the surface part of the molded body 13 is higher in comparison with the central part. Accordingly, the density of the base fiber and the binder fiber of the molded body 13 is increased from the central part toward the surface part.

Since temperature of the surface part of the molded body is raised to the second plasticization temperature band, the binder material of the binder fiber is melted, to melt-connect the base fiber and the binder fiber. Accordingly, since the surface part of the molded body 13 is melt-fixed with the binder material of the binder fiber in the state where the density of the base fiber and that of the binder fiber are high, the surface part of the molded body 13 is hardened in comparison with the central part. Further, when the molded body 13 has a flat-shaped structure and it is bended so as to wrap the predetermined part of the wires 11, the ends of the molded body 13 in the widthwise direction, in contact with each other, are melt-attached to each other with the melted binder material of the binder fiber. On the other hand, when the molded body 13 has a bar-shaped structure and accommodates the predetermined part of the wires 11 inside the slit 131, the inner surface parts of the slit 131 are melt-attached to each other. Accordingly, the molded body 13 has a structure to continuously cover the periphery of the predetermined part of the wires 11.

When the second non-woven fabric or foam is applied to the molded body 13, in the molded body 13, a part, having a temperature at which plastic deformation by thermo plasticity is possible, is plastic-deformed. When the molded body 13 is heated and pressurized, as the temperature of the surface part of the molded body 13 is higher in comparison with that of the central part, the degree of plastic deformation of the surface part of the molded body 13 is higher in comparison with that of the central part. Accordingly, the density of the molded body 13 is increased from the central part toward the surface part.

Further, since the temperature of the surface part of the molded body 13 becomes equal to or higher than the fusing point, the surface part of the molded body 13 is melted. Accordingly, when the second non-woven fabric is applied to the molded body 13, the melted fibers are connected and integrated, and the fiber structure disappears. On the other hand, when the foam is applied to the molded body 13, the foam is melted and bubbles are collapsed. Accordingly, in the surface part of the molded body 13, the density and the hardness are raised in comparison with the fiber state or foam state. Further, when the molded body 13 has a flat-shaped structure and is bended so as to wrap the predetermined part of the wires 11, the ends of the molded body 13 in the widthwise direction are melted and attached to each other. On the other hand, when the molded body 13 has a bar-shaped structure and accommodates the predetermined part of the wires 11 inside the slit 131, the inner surface parts are melted and attached to each other. Accordingly, the molded body 13 continuously covers the periphery of the predetermined part of the wires 11.

Note that the heat emitted from the lower die 52 of the first molding die 5 is transmitted through the lower die holding tool 62 to the molded body 13. As described above, as the lower die holding tool 62 is formed of a material having high thermal conductivity, and the heat is easily transmitted from the outer surface toward the inner surface, the heat emitted from the lower die 52 of the first molding die 5 is easily transmitted to the molded body 13. Accordingly, it is not necessary to set long time as the above-described “predetermined time”.

Next, as shown in FIG. 8, after elapse of the predetermined time, the upper die 51 and the lower die 52 of the first molding die 5 are separated. Then, the predetermined part of the present wire harness 1 (i.e., the molded shape maintenance member 12 and the predetermined part of the wires 11), placed on the lower die holding tool 62, is removed from the lower die.

When the lower die holding tool 62 is formed of a metal plate or the like (i.e., the mass is small), the thermal storage amount is small. Accordingly, when the predetermined part of the present wire harness 1 is removed from the lower die 52 of the first molding die 5, the molded shape maintenance member 12 and the predetermined part of the wires 11 are not heated with the heat emitted from the lower die holding tool 62. This prevents overheating of the predetermined part of the present wire harness 1. Accordingly, the control of the property of the shape maintenance member 12 is facilitated. Further, as the shape maintenance member 12, accommodated in the groove-shaped concave member 623 of the lower die holding tool 62, is removed from the lower die 52 of the first molding die 5, deformation of the molded shape maintenance member 12 due to its own weight or the like is prevented. Since it is not necessary to directly contact with the shape maintenance member 12 upon removal, accidental and/or undesired deformation does not occur in the shape maintenance member 12.

In this manner, it is possible to mold the shape maintenance member 12 to have a predetermined cross-sectional shape by heating and pressurizing the molded body 13. In the surface part of the molded shape maintenance member 12, the density and the hardness are higher in comparison with the molded body 13 before molding. On the other hand, the central part of the shape maintenance member 12, having the physical property of the molded body 13 before molding, is in elastically contact with the predetermined part of the wires.

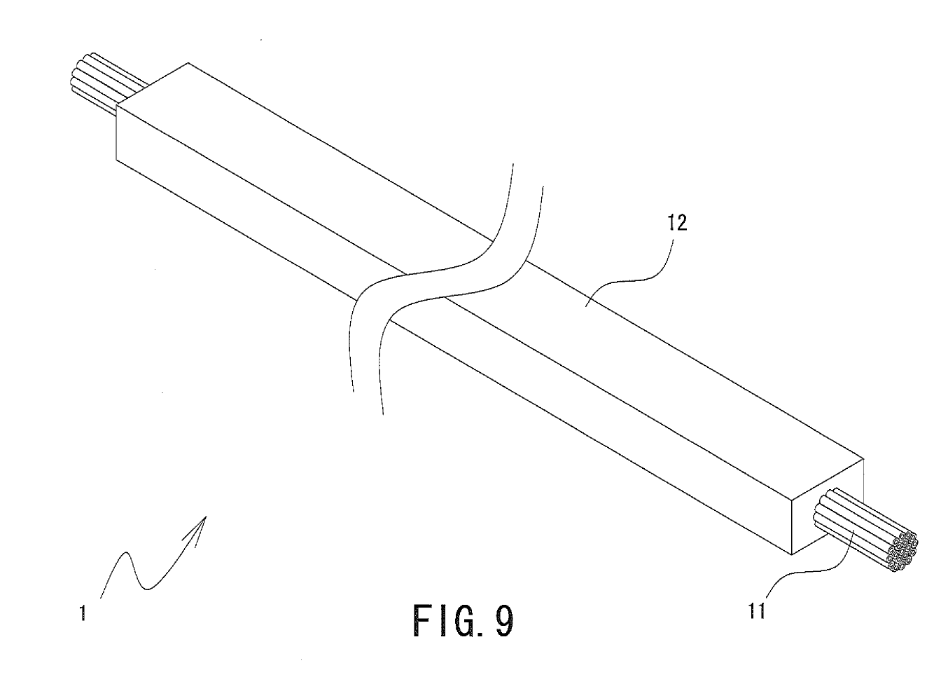

FIG. 9 is an external perspective diagram showing the predetermined part of the present wire harness 1 subjected to the first step. As shown in FIG. 9, through the first step, the shape maintenance member 12 having predetermined cross-sectional shape and size is provided in the predetermined part of the wires 11 of the present wire harness 1. The axial shape of the shape maintenance member 12 is approximately the same as the axial shape of the lower die holding tool 62. For example, as shown in FIG. 9, it is formed in an approximately linear shape. That is, immediately after the first step, the shape maintenance member 12 does not have an axial shape to be finally molded.

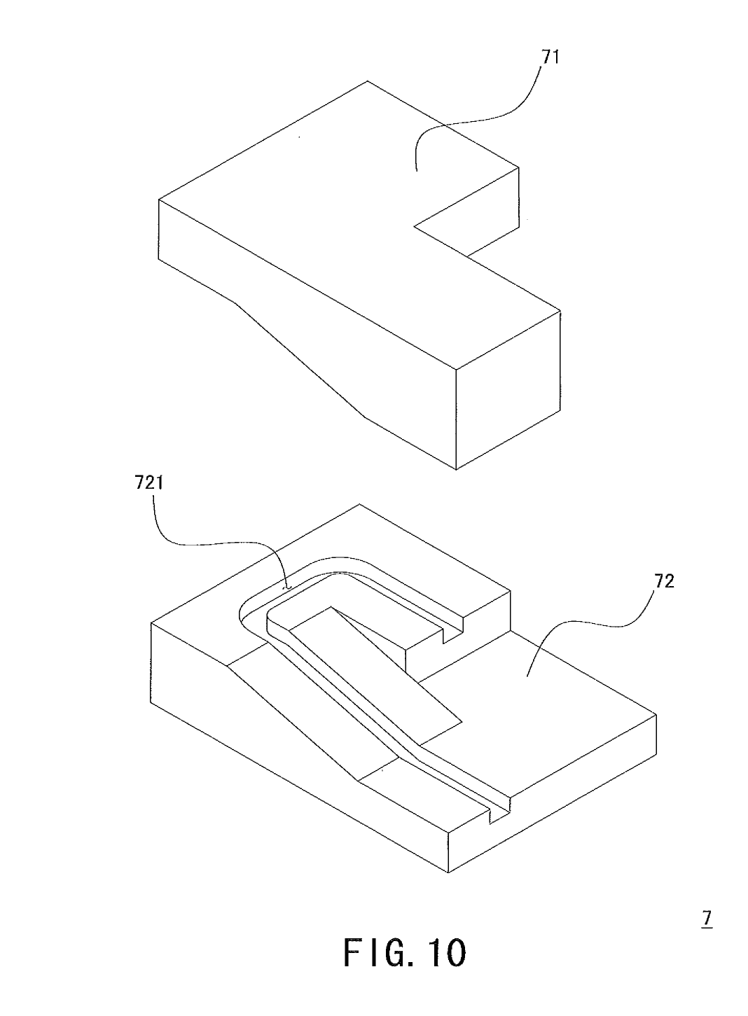

The predetermined part of the present wire harness 1 subjected to the first step is subjected to the second step. The content of the second step is as follows. At the second step, a molding die 7 to mold the axial shape of the shape maintenance member 12 to a predetermined shape is used. This molding die 7 will be referred to as a second molding die 7. FIG. 10 is an exploded perspective diagram schematically showing the structure of the second molding die 7. As shown in FIG. 10, the second molding die 7 has an upper die 71 and a lower die 72.

As shown in FIG. 10, a molding unit 721 is formed in the lower die 72 of the second molding die 7. The molding unit 721 is a groove in which the shape maintenance member 12 is inserted, and its axial shape is set in correspondence with the axial shape of the shape maintenance member 12 to be finally formed. That is, the axial shape and size of the molding unit 721 are the axial shape and size of the finally-manufactured shape maintenance member 12 of the present wire harness 1. Accordingly, the axial shape and size of the molding unit 721 are set in correspondence with the shape and size of the shape maintenance member 12 to be manufactured. The shape of the molding unit 721 shown in FIG. 10 is an example and not limited to this shape.

The upper die 71 of the second molding die 7 has a structure connectable to the lower die 72. When the upper die 71 and the lower die 72 of the second molding die 7 are connected, the size and shape of the space surrounded by the inner surface of the molding unit 721 of the lower die 72 and a part of the upper die 71 facing the molding unit 721 of the lower die 72 are the final size and the shape of the shape maintenance member 12 provided in the predetermined part of the present wire harness 1.

The quality of material of the upper die 71 and the lower die 72 of the second molding die 7 is not particularly limited, but it is preferable that a material with high thermal conductivity is applied. For example, various metal materials such as iron metal materials and aluminum alloy are applicable.

The predetermined part of the present wire harness 1 subjected to the first step (the molded shape maintenance member 12), still having a temperature at which plastic deformation by thermo plasticity is possible, is fitted in the molding unit 721 of the lower die 72 of the second molding die 7, and the upper die 71 and the lower die 72 are connected. That is, when the first non-woven fabric is applied to the shape maintenance member 12, the shape maintenance member 12, while it has a temperature within the first plasticization temperature band, is fitted in the molding unit 721 of the lower die 72 of the second molding die 7, and the upper die 71 and the lower die 72 are connected.

When the shape maintenance member 12 is fitted in the molding unit 721 of the lower die 72 of the second molding die 7, the shape maintenance member 12 is plastic-deformed to a shape corresponding to the shape of the molding unit 721. Particularly, the axial shape of the shape maintenance member 12 is plastic-deformed to a shape the same as the axial shape of the molding unit 721.

Then, this state is maintained until the temperature of the shape maintenance member 12 is lowered to a temperature at which plastic deformation by thermo plasticity does not occur. For example, when the first non-woven fabric is applied to the shape maintenance member 12, this state is maintained until the temperature of the shape maintenance member 12 is lowered to a temperature lower than the temperature of the first plasticization temperature band of the first non-woven fabric.

When the molded shape maintenance member 12 is fitted in the molding unit 721 of the lower die 72 of the second molding die and the upper die 71 and the lower die 72 are connected, the surface of the shape maintenance member 12 is brought into contact with the inner surface of the molding unit 721 of the lower die 72 of the second molding die 7 and the surface of the upper die 71. Then, the heat of the shape maintenance member 12 is transmitted to the the upper die 71 and the lower die 72 of the second molding die 7, and further, radiated from the the upper die 71 and the lower die 72 of the second molding die 7 to the outside (e.g., atmosphere). As described above, when the upper die 71 and the lower die 72 of the second molding die 7 are formed of a material with high thermal conductivity, the heat of the shape maintenance member 12 fitted in the molding unit 721 is quickly transmitted to the upper die 71 and the lower die 72 of the second molding die 7 and the shape maintenance member 12 is quickly cooled down.

When the temperature of the shape maintenance member 12 is lowered to a temperature at which plastic deformation by thermo plasticity does not occur or lower, the upper die 71 and the lower die 72 of the second molding die 7 are separated, and the shape maintenance member 12 is removed from the molding unit 721 of the lower die 72 of the second molding die 7. Through the above process, the present wire harness 1 having the shape maintenance member 12 molded in predetermined shape and size is obtained.

Note that it may be arranged such that the second molding die 7 does not have the upper die 71. That is, when the shape maintenance member 12 can be sufficiently cooled down only with the lower die 71 of the second molding die 7, or when it is not necessary to press the shape maintenance member 12 with the upper die 71 (e.g., there is no probability that the original shape of the shape maintenance member 12 is restored without pressing the shape maintenance member 12 with the upper mold 72), the upper die 72 can be omitted.

Further, as long as the second molding die 7 is a structure to mold the axial shape of the shape maintenance member into a predetermined shape, it is not necessary to use a specialized molding die. For example, it may be arranged such that a real member having a region where the present wire harness 1 is arranged is used as the second molding die 7.

For example, when a wire harness having a part to be arranged in a pillar of an automobile (a strut between a front window or a rear window and a side window, or a strut between side windows) is manufactured, a real pillar may be used as the second molding die 7. Then, the shape maintenance member 12 molded through the first step (the predetermined part of the present wire harness 1) is placed in the pillar in the aspect of actual arrangement. Then, the state is maintained until the temperature of the shape maintenance member 12 is lowered to a temperature at which plastic deformation by thermo plasticity does not occur. With this arrangement, it is possible to mold the shape maintenance member 12 (particularly the axial shape of the shape maintenance member 12) into the shape of space in which it is actually arranged.

Further, when a wire harness having a part to be arranged in a door of an automobile is manufactured, a member as a real door (a door outer plate and a frame attached to the outer plate by welding or the like) may be used as the second molding die 7. Then, through a process similar to the above-described process, it is possible to mold the shape maintenance member 12 into the shape of space in which it is actually arranged.

In this manner, it is possible to use a real member in which the predetermined part of the present wire harness 1 is arranged as the second molding die 7. According to this structure, since it is not necessary to manufacture a specialized second molding die 7, it is possible to reduce the labor and cost required for designing and manufacture of the second molding die and it is possible to reduce the equipment cost. Further, since a real member in which the wire harness is actually arranged is used, it is possible to accurately mold the shape maintenance member 12 into a predetermined shape with high precision.

According to the wire harness manufacturing method according to the embodiment of the present invention, it is possible to mold the shape maintenance member 12 having predetermined cross-sectional shape and size by heating and pressurizing the molded body 13 using the first molding die 5. That is, it is possible to mold the shape maintenance member 12 to cover the predetermined part of the wires 11. By using the second molding die 7, it is possible to mold the shape maintenance member to have a predetermined axial shape and cool the shape maintenance member 12.

Accordingly, even when the axial shape of the shape maintenance member 12 is complicated (e.g., a complicated three-dimensional shape), it is possible to easily mold the shape maintenance member 12 at a low cost. That is, in the structure using an injection molded product, when the axial shape of the shape maintenance member is complicated, designing of the injection molded product is complicated, and the equipment cost is increased. On the other hand, according to the wire harness manufacturing method, it is possible to easily mold the shape maintenance member 12 at a low cost into a shape corresponding to e.g. the shape of space in which the shape maintenance member is arranged.

Further, in comparison with the structure where a tape is wrapped so as to maintain the axial shape of the wires in a predetermined shape, as the content of the work operation is very simplified, the labor and time required for the manufacturing can be reduced. Further, in comparison with the structure where the tape is manually wrapped, the quality can be stabilized. Then, according to the wire harness manufacturing method according to the embodiment of the present invention, the appearance of the manufactured wire harness is good.

By using the second molding die 7, the shape maintenance member 12 is molded to have a predetermined axial shape and is cooled to a temperature at which plastic deformation by thermo plasticity does not occur. Accordingly, when the shape maintenance member 12 is removed from the second molding die, the shape of the shape maintenance member 12 is fixed and plastic deformation by thermo plasticity does not occur. Accordingly, it is possible to mold the shape maintenance member 12 with high measurement precision without accidental and/or undesired deformation in the shape maintenance member 12. Further, handling of the molded shape maintenance member 12 is facilitated.

That is, in the structure where molding is performed using a single molding die to form the molded body to have a cross section in predetermined shape and size and at the same time to mold the axial shape of the shape maintenance member to a predetermined shape, the shape maintenance member immediately after the molding has a temperature at which plastic deformation by thermo plasticity is possible. Accordingly, in some cases, accidental and/or undesired deformation occurs immediately after the molding. On the other hand, according to the wire harness manufacturing method according to the embodiment of the present invention, when the shape maintenance member 12 is removed from the second molding die 7, the shape maintenance member 12 already has a temperature at which plastic deformation by thermo plasticity does not occur. Accordingly, even when an operator touches the molded shape maintenance member 12, accidental deformation or the like does not occur.

Note that in the structure where the shape maintenance member is molded using a single molding die, it may be arranged such that after the molding of the shape maintenance member, the molding die is cooled down and the shape maintenance member is removed. However, in this arrangement, since time for cooling the molding die is required, time required for molding the shape maintenance member is long, and the productive efficiency is lowered. Further, since the shape maintenance member is continuously heated with the molding die before the molding die is cooled down, it is difficult to control the characteristic of the shape maintenance member. Further, since heating and cooling of the molding die are required by each molding of the shape maintenance member, the time required for molding the shape maintenance member is prolonged.

On the other hand, according to the wire harness manufacturing method according to the embodiment of the present invention, it is not necessary to cool the first molding die 5, and it is possible to maintain the first molding die 5 always at a predetermined temperature. Accordingly, it is possible to improve the operating efficiency of the first molding die 5. Further, in comparison with the structure where the molding die is cooled down, since the time required for cooling the shape maintenance member 12 can be shorter than the time required for cooling the molding die (i.e., the thermal storage amount in the molded shape maintenance member 12 is smaller than the thermal storage amount in the molding die), it is possible to reduce the time required for the molding (especially cooling) the shape maintenance member 12.

As long as the unit to heat the molded body 13 is provided only in the first molding die 5, it is not necessarily provided in the second molding die 7. Further, as long as the second molding die 7 has a structure to mold the shape maintenance member 12 to have a predetermined axial shape, it is not necessary to use a specialized molding die. It is possible to use a real member in which the predetermined part of the present wire harness is arranged. Accordingly, it is possible to reduce the manufacturing cost of the second molding die 7, and it is possible to reduce the equipment cost used in the wire harness manufacturing method according to the embodiment of the present invention, or prevent an increase of the equipment cost.

Further, as the shape maintenance member 12 is molded with the second molding die 7 (the molding die without heating unit) to have a predetermined axial shape, the shape of the first molding die 5 (the molding die with a heating unit) and that of the lower die holding tool 62 can be simplified. For example, it is possible to form the lower die holding tool 62 into an approximate liner bar shape, and form the engagement member 521 of the lower die 52 of the first molding die 5 and the pressure surface 512 of the upper die 51 respectively into an approximate linear shape. In this manner, it is possible to form the first molding die 5 having a heating unit into a simple shape. Accordingly, it is possible to reduce the manufacturing cost of the first molding die 5. That is, in comparison with the structure where the molded body is formed with a single molding die to have predetermined shape and size and formed to have a predetermined axial shape, as the shape of the molding die to heat the molded body 13 is simple, it is possible to reduce the manufacturing cost of the molding die.

According to the wire harness manufacturing method according to the embodiment of the present invention, it is possible to harden the surface part of the shape maintenance member 12 and maintain the central part in a soft state (the state having the physical property of the molded body 13 before molding).

That is, the shape maintenance member 12 is fitted in the molding unit 721 of the lower die 72 of the second molding die 7 immediately after the completion of the heating and pressurizing with the first molding die 5 (through the first step), thus the cooling can be quickly started. In the shape maintenance member 12 immediately after the heating and pressurization with the first molding die 5, the temperature of the surface part is high and that of the central part is low. Accordingly, when the shape maintenance member 12 is maintained in this state, the heat of the surface part is transmitted to the central part, and there is a probability of progress of plastic deformation by thermo plasticity in the central part and hardening of the central part. On the other hand, according to the wire harness manufacturing method according to the embodiment of the present invention, the heat of the molded shape maintenance member 12 (especially the heat of the surface part) is quickly transmitted to the second molding die 7. Accordingly, it is possible to prevent progress of the plastic deformation in the central part.

Further, in a structure using the lower die holding tool 62, it is possible to prevent unnecessary heating of the molded body 13 before compression molding with the first molding die 5. That is, in the structure where the molded body 13 and the predetermined part of the wires 11 are directly set in the first molding die 5, when it takes time in this setting work, the molded body 13 is heated before pressurization. Accordingly, in some cases, the temperature of a part of the molded body 13 to be the central part of the shape maintenance member 12 is raised to a temperature at which plastic deformation by thermo plasticity or to a fusing point. Then, in such case, the central part in addition to the surface part of the shape maintenance member 12 may be hardened. Further, there is a probability of damage to the wires 11 by the heat. On the other hand, according to the structure using the lower die holding tool 62, in the work operation to accommodate the molded body 13 and the predetermined part of the wires 11 in the lower die holding tool 62, the molded body 13 is not heated. It is possible to quickly perform pressurization after the engagement of the molded body 13 accommodated in the lower die holding tool 62 with the engagement member 521 of the lower die 52 of the first molding die 5. Accordingly, it is possible to heat the surface part of the molded body 13 to a predetermined temperature and prevent raise of the temperature of the central part to the predetermined temperature.

In this manner, it is possible to easily harden the surface part of the shape maintenance member 12 and prevent hardening of the central part. Further, it is possible to prevent damage to the wires 11 by heat.

According to the wire harness manufacturing method according to the embodiment of the present invention, upon mass production, it is possible to increase the number of products per unit time. For example, it is possible to heat and pressurize one molded body 13 with the first molding die 5, then mold the shape maintenance member 1,2 molded with the one molded body 13, to have a predetermined axial shape, and cool the shape maintenance member 12, while heat and pressurize another molded body 13 with the first molding die 5. This process can be repeatedly performed. In this manner, it is possible to continuously perform the molding of the shape maintenance member 12 using the first molding die 5 and the second molding die 7.

Further, according to the wire harness manufacturing method according to the embodiment of the present invention, in comparison with the structure using the shape maintenance member which is an injection molded product, the following advantages can be obtained.

The first molding die 5 and the second molding die 7, used in the wire harness manufacturing method according to the embodiment of the present invention, respectively have a simple structure in comparison with the metal molding die to manufacture an injection molded product (so-called injection molding metal die), therefore they can be manufactured at a low cost, and the equipment cost can be reduced. Further, according to the wire harness manufacturing method according to the embodiment of the present invention, in comparison with the structure using the shape maintenance member or the protector which is an injection molded product, since a lower-cost material (commercially available low-cost thermoplastic material) is applied to the shape maintenance member 12, it is possible to manufacture the present wire harness at a low cost. Accordingly, it is possible to reduce the product price.

Then, at the first step and the second step in the wire harness manufacturing method according to the embodiment of the present invention, in comparison with the method of fitting the wires in the protector or the shape maintenance member which is an injection molded product, the work operation is simple.

Further, in the structure using the protector or the shape maintenance member which is an injection molded product, when there is a gap between the inner surface of the protector or the shape maintenance member and the wires, the wires collide with the inner surface of the protector or the shape maintenance member, and an impulsive sound or the like occurs. Note that it may be arranged such that a shock-absorbing material such as a sponge-type member is provided inside the shape maintenance member or the protector to prevent the impulsive sound or the like. However, in this arrangement, the number of parts and the number of process steps are increased, and the manufacturing cost or the product price may be increased.

According to the wire harness manufactured by the wire harness manufacturing method according to the embodiment of the present invention, the predetermined part of the wires 11 is wrapped with the shape maintenance member 12, in elastically contact with the shape maintenance member 12. Accordingly, an impulsive sound or the like does not occur between the wires 11 and the shape maintenance member 12. Further, the shape maintenance member 12 also functions as a protector or a shock absorbing material to guard the predetermined part of the wires 11 from impact or vibration. In this manner, since the increase in the number of parts and the number of process steps are prevented, it is possible to reduce the cost of the parts and the manufacturing cost.

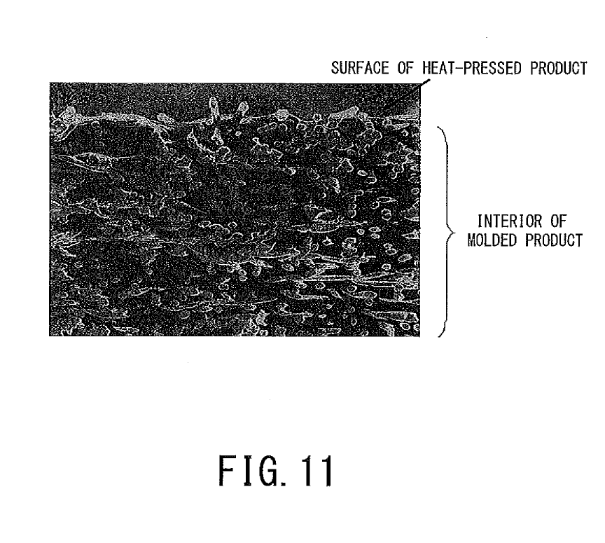

Further, in the present embodiment, the molded body 13 is molded using non-woven fabric of a thermoplastic material. Accordingly, as shown in FIG. 11, the shape maintenance member 12 becomes a layer including plenty of air. In the layer including plenty of air, as the heat insulating property is improved with the air, it is not easily cooled down. According to the present embodiment, (in comparison with a case where the shape maintenance member is a bulk), the shape maintenance member 12 is not easily cooled down from the heating and pressurization of the molded body 13 and the molding of the shape maintenance member 12 to have a predetermined axial shape. Accordingly, the work operation to mold the shape maintenance member 12 to the predetermined axial shape (the second step) is facilitated. That is, time allowance occurs in the second step to be performed “while the shape maintenance member 12 has a plastic-deformable temperature”.

Various embodiments of the present invention have been described in detail. Further, the present invention is not limited to the above-described respective embodiments, and various changes can be made within a scope not departing from the subject matter of the present invention.

In the above-described wire harness manufacturing method according to the embodiment of the present invention, the cross-sectional shape of the shape maintenance member is formed to an approximate rectangular shape. However, the cross-sectional shape and size of the shape maintenance member is not particularly limited.

For example, the cross-sectional shape of the main body of the shape maintenance member or the entire cross-sectional shape of the shape maintenance member may be an approximate rectangular shape or the like. Further, it may be top-and-bottom or right-and-left asymmetrical shape. When the cross-sectional shape is an approximate rectangular shape, a structure where a groove-shaped concave member is formed on the upper side is applied to the lower die holding tool. Then a groove-shaped concave member having a rectangular cross-sectional shape is formed in the pressure surface is applied to the upper die. In this manner, by forming the cross-sectional shape of the upper surface of the bottom of the lower die holding tool and the cross-sectional shape of the pressure surface of the upper die into various shapes, it is possible to mold the cross-sectional shape of the shape maintenance member in the predetermined part of the wire harness into various shapes.

Further, the axial shape of the shape maintenance member is appropriately set in correspondence with the shape of space in which the wire harness is arranged or convenience of arrangement work, but is not limited.

Further, in the above-described embodiments, the predetermined part of the wires is wrapped with a single molded body. However, it may be arranged such that the predetermined part of the wires is held between plural molded bodies.

1. A wire harness manufacturing method for manufacturing a wire harness in which a predetermined part of a wire is covered with a thermoplastic material, comprising:
a first step of covering a periphery of the wire with the thermoplastic material, and heating the thermoplastic material to a temperature at which plastic deformation by thermo plasticity is possible and pressuring the thermoplastic material to mold the thermoplastic material to have predetermined cross-sectional shape and size; and
a second step of, after the first step, while the thermoplastic material has the temperature at which plastic deformation by thermo plasticity is possible, molding the thermoplastic material to have a predetermined axial shape, and cooling the thermoplastic material having the predetermined axial shape.

2. The wire harness manufacturing method according to claim 1, wherein at the second step, by using one molding die with a groove-shaped molding member in which the thermoplastic material having the predetermined axial shape subjected to the first step is fitted and by fitting the thermoplastic material subjected to the first step in the molding member formed in the one molding die, the axial shape of the thermoplastic material is formed to a predetermined shape, and the thermoplastic material is cooled by transmitting heat of the thermoplastic material to the molding die.

3. The wire harness manufacturing method according to claim 1, wherein at the first step, the thermoplastic material is molded to have the predetermined cross-sectional shape by heating the thermoplastic material to the temperature at which plastic deformation by thermo plasticity is possible and pressurizing the thermoplastic material, using another molding die.

4. A wire harness manufacturing method for manufacturing a wire harness in which a predetermined part of a wire is covered with non-woven fabric of a thermoplastic material, comprising:
a first step of covering a periphery of the wire with the non-woven fabric of the thermoplastic material, and heating the non-woven fabric of the thermoplastic material to a temperature at which plastic deformation by thermo plasticity is possible and pressurizing the non-woven fabric to mold the non-woven fabric to have predetermined cross-sectional shape and size; and
a second step of, after the first step, while the non-woven fabric of the thermoplastic material has the temperature at which plastic deformation by thermo plasticity is possible, molding the thermoplastic material to have a predetermined axial shape, and cooling the thermoplastic material having the predetermined axial shape.

5. The wire harness manufacturing method according to claim 4,
wherein the non-woven fabric has base fiber and binder fiber,
wherein the base fiber is formed of a thermoplastic resin material having a predetermined fusing point,
wherein the binder fiber has a layer of core fiber and binder material formed on the outer periphery of the core fiber,
wherein the core fiber is formed of a thermoplastic resin material having a predetermined fusing point, and
wherein the binder material layer is formed of a thermoplastic resin material having a fusing point lower than those of the base fiber and the core fiber.
